(19) United States
(12) Patent Application Publication
(10) Pub. No.: US 2009/0046262 A1
(43) Pub. Date: Feb. 19, 2009

(54) EXPOSURE APPARATUS AND EXPOSURE METHOD

(75) Inventors: Yoji Okazaki, Kanagawa-ken (JP); Hiromi Ishikawa, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 11/817,466

(22) PCT Filed: Mar. 9, 2006
(86) PCT No.: PCT/JP2006/305181

§ 371 Date: Aug. 30, 2007

(30) Foreign Application Priority Data
Mar. 15, 2005 (JP) 2005-072285

(51) Int. Cl. G03B 27/38

(52) U.S. Cl. 355/52

(57) ABSTRACT

An exposure apparatus includes a light source for emitting exposure light, a spatial light modulation means for performing spatial light modulation, based on an image signal, on the exposure light, an imaging means for forming an image on a photosensitive material with the exposure light on which spatial light modulation has been performed, and a focus adjustment means for adjusting focus by changing the optical path length of the modulated exposure light when an image is formed on the photosensitive material with the spatially modulated exposure light. The imaging means forms an image with the spatially modulated exposure light only by a substantially rectangular region of the imaging means including the central portion of the imaging means.

### TECHNICAL FIELD

The present invention relates to an exposure apparatus for exposing a photosensitive material to light by projecting light, on which spatial light modulation has been performed, thereonto through an imaging optical system. The present invention also relates to its exposure method.

### BACKGROUND ART

Conventionally, an exposure apparatus which includes a spatial light modulation means is well known. The spatial light modulation means performs spatial light modulation, based on an image signal, on incident light, and forms an image. In the exposure apparatus, the two-dimensional pattern formed by the spatial light modulation means is projected onto a photosensitive material so as to expose the photosensitive material to light. As the spatial light modulation means, a digital micromirror device (hereinafter, referred to as “DMD”) is well known (please refer to Japanese Unexamined Patent Publication No. 2001-305663). In the DMD, a multiplicity of micromirrors is two-dimensionally arranged (for example, 1024 pixels×756 pixels), and an inclination angle of each of the micromirrors can be changed. For example, a DMD developed by Texas Instruments Incorporated, U.S. is well known.

In the exposure apparatus which includes the DMD, as described above, an imaging means including a projection lens for forming an image of the two-dimensional pattern with light is also provided. The projection lens forms an image only with light reflected by micromirrors of the DMD, which are inclined at a predetermined angle. In other words, the exposure apparatus performs exposure so that each pixel forming the two-dimensional pattern projected onto the photosensitive material corresponds to each of the micromirrors.

In the exposure apparatus according to the related art, a substantially entire region of the projection lens was used to form a two-dimensional pattern on a photosensitive material. In that case, it was necessary to suppress field curvature, astigmatic difference, distortion or the like through the entire region of the projection lens and to improve the telecentric characteristic of the projection lens so that the projection lens has high optical performance. However, it was necessary to improve the accuracy of parts and to select better parts to produce the projection lens which has high optical performance through the substantially entire region of the lens. Therefore, the production cost of the projection lens was high. Further, since it was difficult to produce a large diameter projection lens which has high optical performance through the entire region thereof, it was impossible to expose a large area of the photosensitive material to light. Further, exposure speed was low.

If the optical performance of the projection lens is low, the accuracy of beam positions drops. Therefore, it was necessary to increase the number of times of multiple exposure. This caused problems such as lower exposure speed, a lower image quality, or the like, and the exposure performance of the exposure apparatus deteriorated.

### DISCLOSURE OF INVENTION

In view of the foregoing circumstances, it is an object of the present invention to provide an exposure apparatus and method for improving exposure performance without increasing a production cost or lowering exposure speed.

An exposure apparatus according to the present invention is an exposure apparatus comprising:

a light source for emitting exposure light;

a spatial light modulation means for performing spatial light modulation, based on an image signal, on the exposure light emitted from the light source;

an imaging means for forming an image on a photosensitive material with the exposure light on which spatial light modulation has been performed; and

a focus adjustment means for adjusting focus by changing the optical path length of the exposure light on which spatial light modulation has been performed when the image is formed on the photosensitive material with the exposure light on which spatial light modulation has been performed, wherein the imaging means forms the image only by a substantially rectangular region thereof, including a central portion thereof, with the exposure light on which spatial light modulation has been performed.

Here, the imaging means is an imaging means which has high optical performance in a region including a central portion thereof. The optical performance in the region including the central portion is improved by increasing distortion in the peripheral region of the imaging means and by correspondingly reducing distortion in the region including the central portion.

Further, in the exposure apparatus according to the present invention, the imaging means forms the image by a substantially rectangular region of the imaging means, of which the length of the longer side is twice or more of that of the shorter side thereof, with the exposure light on which spatial light modulation has been performed.

Here, it is preferable that the length of the longer side of the substantially rectangular region is approximately twice through five times of that of the shorter side thereof.

In the exposure apparatus according the present invention, the focus adjustment means includes a pair of wedge prisms, of which the thickness in the direction of the optical axis of the exposure light on which spatial light modulation has been performed changes. Further, focus is adjusted by moving at least one of the pair of wedge prisms when the image is formed on the photosensitive material with the exposure light on which spatial light modulation has been performed.

Further, in the exposure apparatus according to the present invention, the focus adjustment means includes an optical system and a piezo element, and focus is adjusted by adjusting a distance from the optical system to the photosensitive material when the image is formed on the photosensitive material with the exposure light on which spatial light modulation has been performed.

Further, in the exposure apparatus according to the present invention, the imaging means includes a lens. The imaging means can rotate on the optical axis of the lens or move vertically with respect to the optical axis thereof.

In the exposure apparatus according to the present invention, the light source may be a laser light source which emits laser beam emitted by a semiconductor laser element.

Further, in the exposure apparatus according to the present invention, the laser light source may be a bundle-type fiber light source formed by bundling a plurality of optical fibers. In the bundle-type fiber light source, laser beam emitted by the semiconductor laser element is incident on an end of each of the optical fibers and emitted from the opposite end thereof.

Further, in the exposure apparatus according to the present invention, the fiber light source may multiplex laser beams emitted by a plurality of semiconductor laser elements by causing the laser beams to be incident on a single optical fiber.

An exposure method according to the present invention is an exposure method comprising the steps of:

emitting exposure light;

performing spatial light modulation, based on an image signal, on the emitted exposure light;

forming an image on a photosensitive material by an imaging means with the exposure light on which spatial light modulation has been performed; and

adjusting focus by changing the optical path length of the exposure light on which spatial light modulation has been performed when the image is formed on the photosensitive material with the exposure light on which spatial light modulation has been performed, wherein in the step of forming the image, the image is formed only by a substantially rectangular region of the imaging means, including a central portion thereof, with the exposure light on which spatial light modulation has been performed, and wherein exposure is performed in a manner in which the direction of the shorter side of the substantially rectangular region is a wave direction of the photosensitive material.

Further, in the exposure method according to the present invention, the step of emitting exposure light may be a step of emitting laser beam emitted by a semiconductor laser element as the exposure light.

An imaging means which has high optical performance in the region including the central portion thereof is provided by increasing distortion in the peripheral region of a projection lens which forms the imaging means and by correspondingly reducing distortion in the region including the central portion thereof. Further, a region which has high optical performance is used to form an image with the exposure light on which spatial light modulation has been performed. Therefore, it is possible to improve an image quality when the exposure light on which spatial light modulation has been performed is projected onto the photosensitive material.

Further, it was difficult to produce a large diameter projection lens which has sufficient optical performance through the entire region of the projection lens, which forms the imaging means. However, it is possible to produce a large diameter projection lens which has high optical performance by increasing distortion in an arbitrary region thereof, such as a peripheral region thereof, and by reducing distortion in the region including the central portion thereof. Accordingly, it is possible to increase an exposure area and exposure speed.

Further, it is possible to selectively illuminate a high optical performance region of the projection lens, which forms the imaging means, with light on which spatial light modulation has been performed. The high optical performance region of the projection lens can be selectively illuminated because the imaging means can rotate on the optical axis of the exposure light on which spatial light modulation has been performed or move vertically with respect to the optical axis thereof.

Further, the distortion in the peripheral portion of the projection lens or like is increased, and the high performance region thereof, including the central portion, is used. Therefore, the size of the optical system of the focus adjustment means can be reduced compared with that of an optical system in which the entire region of the projection lens is used. Consequently, a highly accurate stable holding/moving mechanism can be realized. Further, highly accurate focal position adjustment is enabled while the light position of the exposure light on which spatial modulation has been performed is stably maintained.

Further, when the exposure light on which spatial light modulation has been performed is condensed into a smaller spot by a microlens array, the size of the microlens array, which is expensive, can be reduced. Therefore, it is possible to adopt a low-cost microlens array which has higher pitch accuracy. Further, since the piezo element is used as the focus adjustment means, it is possible to suppress microdisplacement in a direction perpendicular to that of focus. Therefore, it is possible to accurately adjust the focal position while maintaining the high accuracy in beam positions.

Further, laser beams emitted from a plurality of semiconductor laser elements are caused to be incident on a single optical fiber, and the laser beams are multiplexed. Further, a fiber-bundle-type light source is used. The fiber-bundle-type light source is a high-luminance light source which has a large amount of light per unit area. Therefore, it is possible to increase the optical power of light and to lower Etendue at the same time. Hence, the numerical aperture (NA) of light which illuminates an object to be illuminated (DMD, digital micromirror device) can be reduced. Accordingly, even if spatial light modulation is performed only on a substantially rectangular region of the imaging means, including the central portion thereof, by the spatial light modulation means, the numerical aperture of light which illuminates the object to be illuminated (DMD) can be reduced. Further, even if the imaging optical system is arranged on the downstream side of the object to be illuminated, the focal depth of the imaging optical system can be increased. Accordingly, it is possible to suppress an out-of-focus blur of a formed exposure image.

Further, the imaging means forms an image by the substantially rectangular region of the imaging means with exposure light on which spatial light modulation has been performed and projects the exposure light onto the photosensitive material. The length of the longer side of the substantially rectangular region is twice or more of that of the shorter side thereof. When the photosensitive material is exposed to light, the imaging means is placed in a manner in which the direction of the shorter side of the rectangular region is the wave direction of the photosensitive material. Accordingly, it is possible to reduce the degree of the wave of the photosensitive material in the projection area of the projected exposure light on which spatial light modulation has been performed. Therefore, the focal position of the exposure light on which spatial light modulation has been performed can be adjusted to an appropriate position. Hence, the exposure apparatus can operate as if the focal depth thereof is larger than that of an exposure apparatus according to the related art. Accordingly, the quality of the image formed by exposure can be improved.

### BRIEF DESCRIPTION OF DRAWINGS

FIG. 1 is a schematic external view of an exposure apparatus;

FIG. 2 is a schematic external view of a scanner;

FIG. 3 is a diagram illustrating the internal structure of an exposure head in detail;

FIG. 4 is a diagram illustrating the structure of a light source unit;

FIG. 5 is a diagram illustrating the structure of a laser emission portion;

FIG. 6 is a diagram illustrating the structure of an LD module;

FIG. 7 is a diagram for explaining an optical element forming the exposure head;

FIG. 8A is a plan view of a projection lens;

FIG. 8B is a plan view of a projection lens;

FIG. 9A is a schematic sectional side view of a lens barrel including an imaging optical system;

FIG. 9B is a schematic plan view of the lens barrel;

FIG. 10 is a schematic perspective view of a DMD;

FIG. 11A is a diagram for explaining a region of the DMD, in which used micromirrors are located;

FIG. 11B is a diagram for explaining a region of the DMD, in which used micromirrors are located;

FIG. 12 is a diagram illustrating a side view of a pair of wedge prisms;

FIG. 13 is a schematic perspective view of the pair of wedge prisms;

FIG. 14 is a diagram for explaining optical elements forming the exposure head;

FIG. 15A is a diagram illustrating a structure in which a microlens array and a piezo element are provided;

FIG. 15B is a diagram illustrating a structure in which a microlens array and a piezo element are provided;

FIG. 16A is a diagram illustrating a structure in which a microlens array and a piezo element are provided;

FIG. 16B is a diagram illustrating a structure in which a microlens array and a piezo element are provided;

FIG. 17A is a schematic perspective view of a photosensitive material and the DMD for illustrating a positional relationship therebetween; and

FIG. 17B is a schematic side view of the photosensitive material and the DMD for illustrating a positional relationship therebetween.

### BEST MODE FOR CARRYING OUT THE INVENTION

Hereinafter, an exposure apparatus and an exposure method according to the present invention will be described with reference to the attached drawings.

### 1. Structure of Exposure Apparatus

### 1-1 External View of Exposure Apparatus

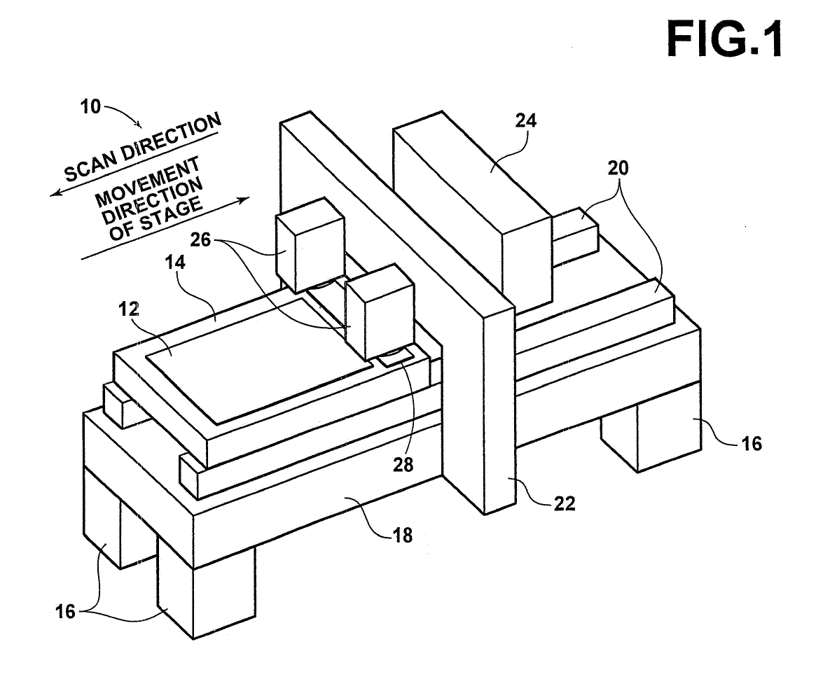

First, an external view of the exposure apparatus will be described. FIG. 1 is a schematic external view of an exposure apparatus 10. The exposure apparatus 10 includes a moving stage 14 which is a flat plate. The moving stage 14 holds a sheet of photosensitive material 12 by attaching the sheet of photosensitive material 12 to the surface thereof by suction. Further, two guides 20 extending along the movement direction of the stage are provided on the upper surface of a base 18 which is a thick plate. The base 18 is supported by four leg members 16. The stage 14 is arranged in a manner in which the longitudinal direction of the stage 14 becomes the movement direction of the stage 14. Further, the stage 14 is supported by the guides 20 so that the stage 14 can move back and forth. Further, the exposure apparatus 10 includes a stage drive apparatus (not illustrated). The stage drive apparatus drives the stage 14 along the guides 20.

Further, an angular inverted-U-shaped gate 22 which straddles the moving path of the stage 14 is set at a central portion of the base 18. Each end of the angular inverted-U-shaped gate 22 is fixed onto either side of the base 18. A scanner 24 is set on one side of the gate 22, and a plurality of sensors 26 is set on the other side of the gate 22. The plurality of sensors 26 detects the leading edge and the rear edge of the photosensitive material 12. Each of the scanner 24 and the sensors 26 is fixed onto the gate 22, and they are set above the moving path of the stage 14. Further, the scanner 24 and the sensors 26 are electrically connected to a controller (not illustrated), and the controller controls the operations of the scanner 24 and the sensors 26.

Further, an exposure surface measurement sensor 28 is set on the stage 14. The exposure surface measurement sensor 28 detects an amount of laser light with which an exposure surface of the photosensitive material 12 is illuminated by the scanner 24 when the scanner 24 starts exposure. The exposure surface measurement sensor 28 is provided at an exposure-starting-side end of the surface of the stage 14, on which the photosensitive material 12 is set. The exposure surface measurement sensor 28 is provided so as to extend in a direction perpendicular to the movement direction of the stage.

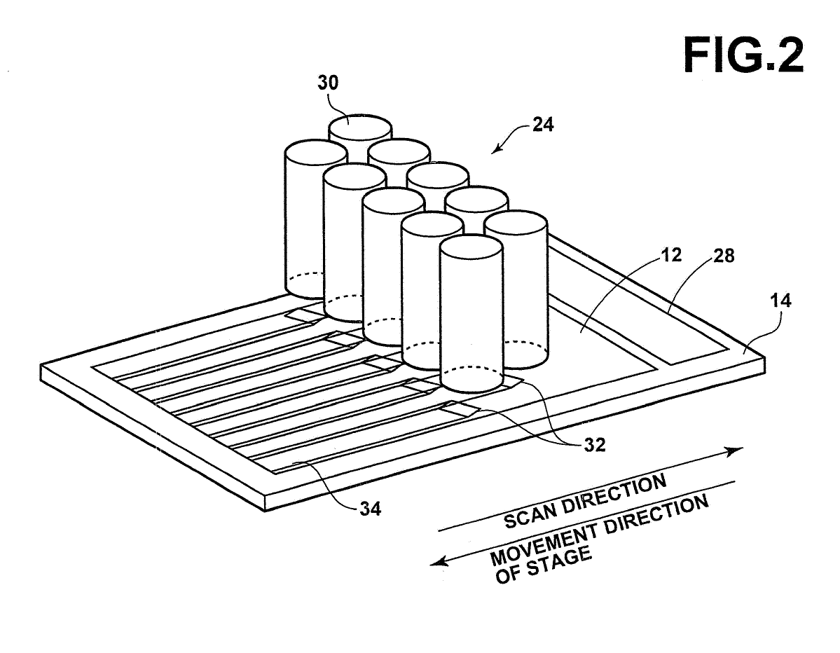

FIG. 2 is a schematic external view of the scanner 24. As illustrated in FIG. 2, the scanner 24 includes, for example, 10 exposure heads 30 of five rows by two columns, which are substantially arranged in a matrix shape. Each of the exposure heads 30 has a DMD (digital micromirror device), and a two-dimensional pattern formed by the DMD is projected onto the photosensitive material 12. An exposure area 32 is a projection area of the two-dimensional pattern on the photosensitive material 12 when the two-dimensional pattern emitted from each of the exposure heads 30 is projected onto the photosensitive material 12. Further, a band-shaped exposed region 34 is formed on the photosensitive material 12 by the exposure head 30 as the stage 14 moves.

### 1-2 Exposure Head

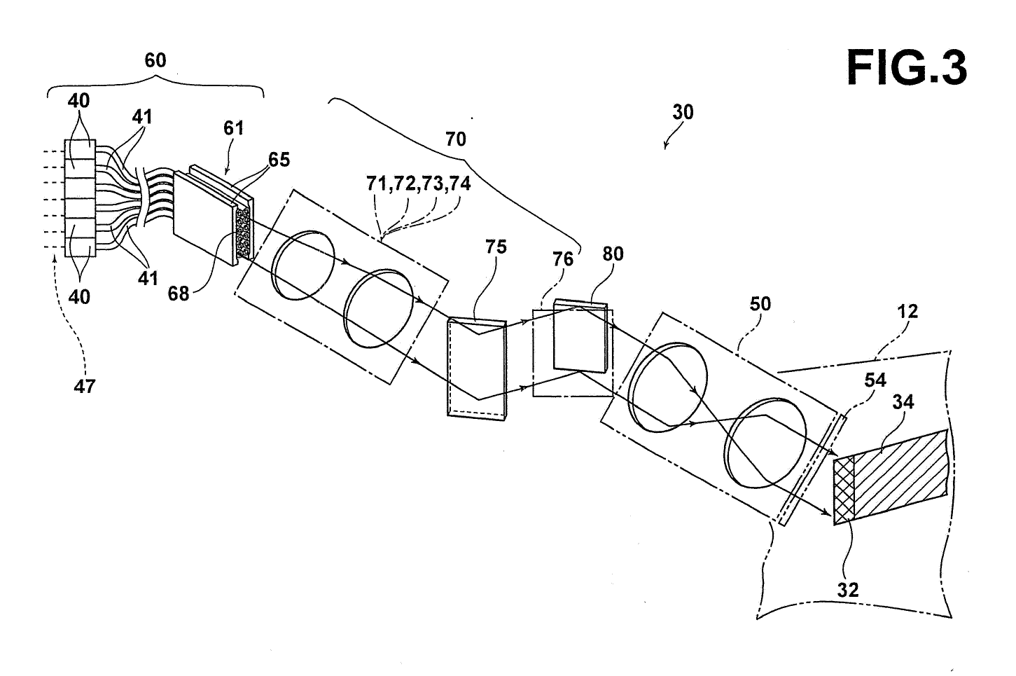

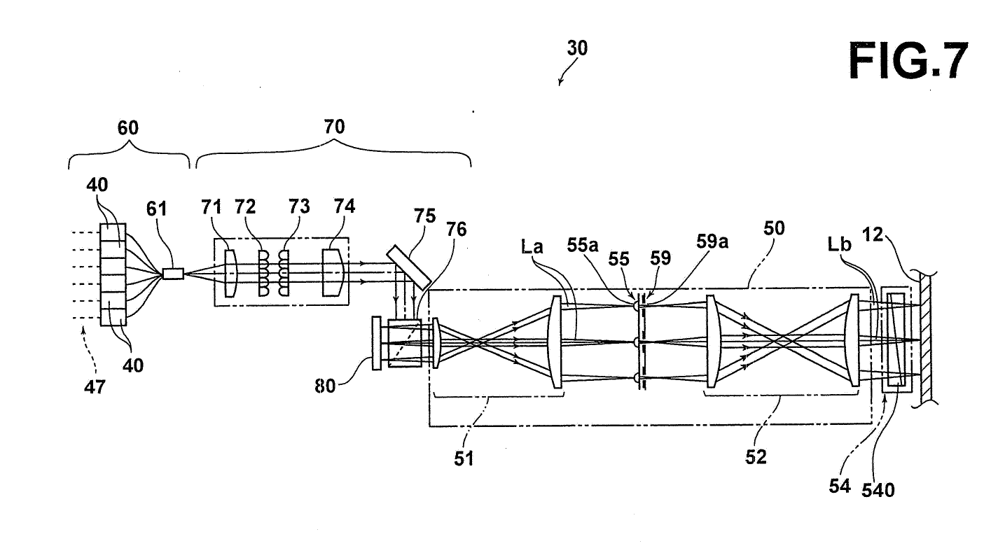

FIG. 3 is a schematic conceptual diagram for explaining the structure of the exposure head 30. FIG. 7 is a diagram for explaining optical elements forming the exposure head 30 along the optical path of the laser beam which propagates through the exposure head 30. The exposure head 30 includes a light source unit 60 which is a light source. The exposure head 30 also includes a DMD illumination optical system 70, a DMD 80, an imaging optical system 50, and a pair 54 of wedge prisms.

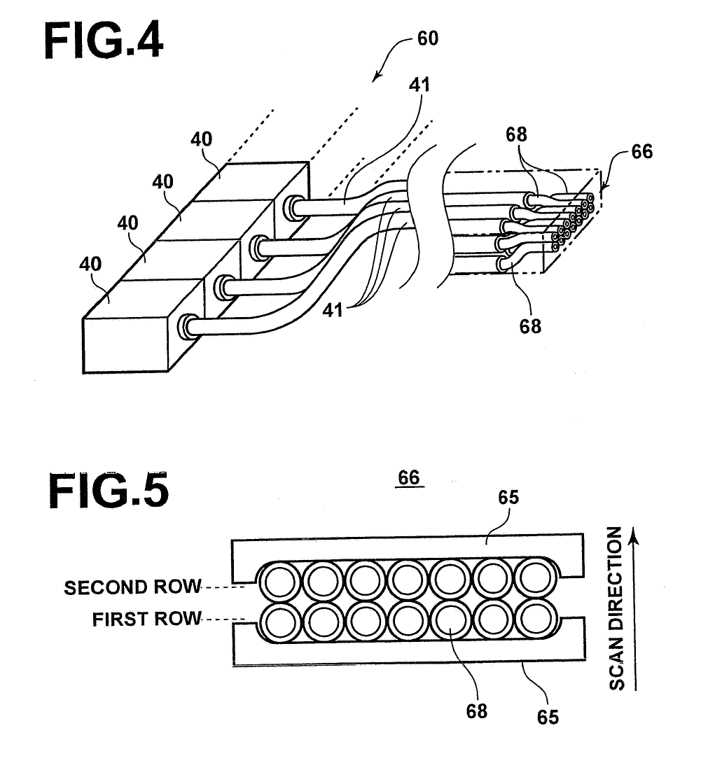

As illustrated in FIG. 4, the light source unit 60 includes a plurality of LD (laser diode) modules 40 (for example, 14 LD modules 40). Each of the LD modules 40 is connected to an end of a first multimode optical fiber 41. The other end of the first multimode optical fiber 41 is connected to a second multimode optical fiber 68. The second multimode optical fiber 68 has a cladding diameter less than that of the first multimode optical fiber 41.

As illustrated in FIG. 5 in detail, seven second multimode optical fibers 68 are arranged so that an end of each thereof, opposite to the end thereof connected to the first multimode optical fiber 41, is aligned in a direction perpendicular to a scan direction. Further, other seven second multimode optical fibers 68 are aligned in a similar manner so as to form another row. The ends of the second multimode optical fibers 68 are aligned in two rows, and a laser emission portion 66 is formed.

As illustrated in FIG. 5, the laser emission portion 66 which is formed by the ends of the second multimode optical fibers 68 is fixed by being sandwiched between two support plates 65 which have flat surfaces. Further, it is preferable that a transparent protective plate such as a glass plate is placed on the surface of the light emission end of the second multimode optical fiber 68 so as to protect the surface thereof. Since the density of light is high at the surface of the light emission end of the second multimode optical fiber 68, dust particles easily accumulate thereon, and the performance of the laser emission portion 66 easily deteriorates. However, if the protective plate as described above is arranged on the surface, it is possible to prevent dust particles from attaching to the surface of the light emission end. Further, it is possible to delay deterioration in the performance of the laser emission portion 66.

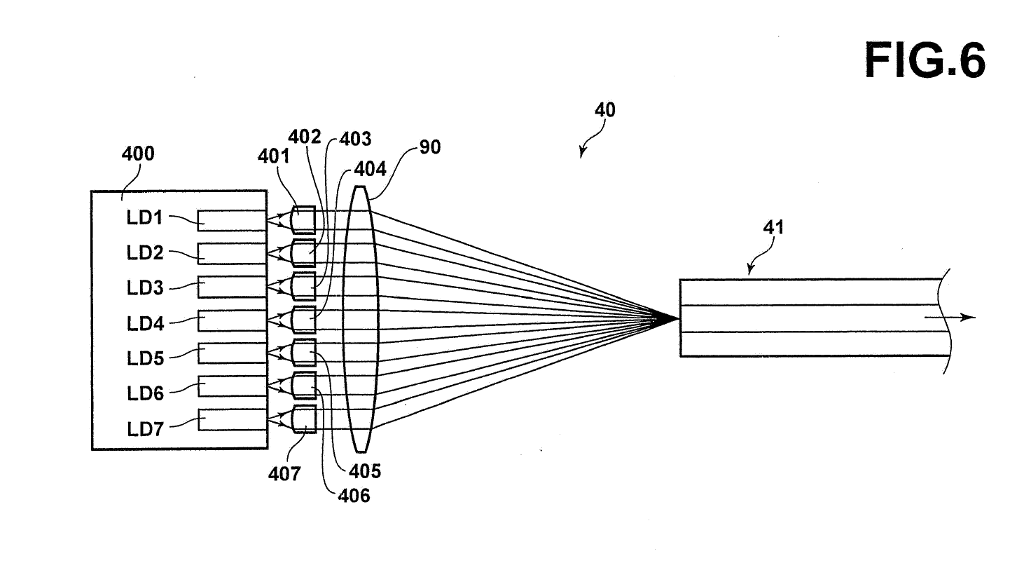

The LD module 40 includes a multiplex laser light source, as illustrated in FIG. 6. The multiplex laser light source includes a plurality of LD chips LD1, LD2, LD3, LD4, LD5, LD6 and LD7 (for example, seven LD chips). The LD chips are semiconductor laser elements, and they are arranged on a heat block 400 and fixed thereto. The multiplex laser light source also includes collimator lenses 401, 402, 403, 404, 405, 406 and 407 corresponding to the LD chips LD1, LD2, LD3, LD4, LD5, LD6 and LD7, respectively. The multiplex laser light source also includes a single condensing lens 90 and a single first multimode optical fiber 41. The number of the semiconductor laser elements is not limited to seven, and it may be another number. Further, a collimator lens array may be used instead of the seven collimator lenses 401 through 407. In the collimator lens array, a plurality of collimator lenses is integrated.

The LD chips LD1 through LD7 are chip-shaped GaN-based (Gallium nitride) semiconductor laser elements of a lateral multimode or single-mode. Each of the LD chips LD1 through LD7 has the same oscillation wavelength (for example, approximately 405 [nm]), and the same maximum output power (for example, 100[mW] in a multimode laser and 30[mW] in a single-mode laser). A semiconductor laser element which has an oscillation wavelength other than 405 [nM] may be uses as each of the LD chips LD1 through LD7 as far as the oscillation wavelength is within the range of 350 [nM] through 450 [nM].

As described above, laser beams emitted from the plurality of LD chips LD1 through LD7 are multiplexed by causing the laser beams to be incident on the single multimode optical fiber 41. Further, a fiber-bundle-type light source is used. The fiber-bundle-type light source is a light source, which emits high luminance light per unit area. Accordingly, it is possible to lower Etendue while increasing the optical power of the light source. Since only a region of the imaging means, including the central portion thereof, is used when the spatial light modulation means performs spatial light modulation, an illuminated region with respect to the object (DMD) to be illuminated becomes smaller. However, since the light source as described above is used, it is possible to suppress the value of an illumination NA (numerical aperture). Therefore, even if the imaging optical system is placed on the downstream side of the object to be illuminated, it is possible to increase the focal depth of the imaging optical system. Further, there is an advantageous effect that an out-of-focus blur in an exposure image formed by the imaging optical system can be suppressed. A relationship between Etendue and the focal depth is described in detail in Japanese Unexamined Patent Publication No. 2005-018013.

In the above description, exposure light is generated by multiplexing beams emitted from the plurality of LD chips LD1 through LD7. However, the exposure light may be generated without multiplexing beams. The semiconductor laser element and an end of the optical fiber may be connected to each other in one-to-one correspondence, and the other end of the optical fiber may be connected to another optical fiber which has a cladding diameter less than that of the optical fiber. In that case, it is preferable that a high output multimode laser is used as the semiconductor laser element. Since the high output laser as described above is used, it is possible to realize a highly accurate light source.

The DMD illumination optical system 70 includes a collimator lens 71, micro fly eye lenses 72 and 73, a field lens 74, a mirror 75, and a prism 76 (please refer to FIG. 7). The collimator lens 71 substantially collimates a plurality of laser beams emitted from the laser light emission portion 61. Each of the micro fly eye lenses 72 and 73 is formed by arranging a multiplicity of microlens cells vertically and horizontally. The micro fly eye lenses 72 and 73 are used to evenly distribute the amount of the laser light which illuminates the DMD 80. The laser beam which has been transmitted through the micro fly eye lenses 72 and 73 is transmitted through a field lens 74. Then, the beam is reflected by the mirror 75, and is incident on the prism 76. The prism 76 is a TIR (total internal reflection) prism. The prism 76 totally reflects the laser beam reflected by the mirror 75. The laser beam reflected by the mirror 75 is totally reflected toward the DMD 80. The DMD 80 will be described in detail later. Further, the DMD illumination optical system 70 may include a rod integrator as a means for evenly distributing the amount of light.

### 1-2-1 Imaging Optical System

The imaging optical system 50 is an imaging means for forming a two-dimensional pattern, which is generated by performing spatial light modulation at the DMD 80, on the photosensitive material 12 by projecting the two-dimensional pattern thereonto. As illustrated in FIG. 7, the imaging optical system 50 includes a first projection lens 51, a second projection lens 52, a microlens array 55, and an aperture array 59. Light is reflected by each of micromirrors of the DMD 80, and a two-dimensional pattern is formed. The two-dimensional pattern is transmitted through the first projection lens 51, and magnified a predetermined times (for example, three times). Accordingly, a magnified image is formed. Here, light flux La which has been transmitted through the first projection lens 51 is condensed separately by each of microlenses 55a of the microlens array 55. The microlens array 55 is arranged in the vicinity of an image formation position of the first projection lens 51. The light flux condensed by each of the microlenses 55a is transmitted through an aperture 59a, and an image is formed. The two-dimensional pattern formed by transmitting the light flux through the microlens array 55 and the aperture array 59 is further transmitted through the second projection lens 52. The two-dimensional pattern is further magnified a predetermined times (for example, 1.67 times). Then, the two-dimensional pattern is transmitted through the pair 54 of wedge prisms, and an image is formed on the photosensitive material 12. Finally, the two-dimensional pattern formed by the DMD 80 is magnified and projected onto the photosensitive material 12. The two-dimensional pattern is magnified by the product of the magnification ratio of the first projection lens 51 and the magnification ratio of the second projection lens 52 (for example, 3 times×1.67 times=5 times). Here, it is not necessary that the imaging optical system 50 includes the second projection lens 52.

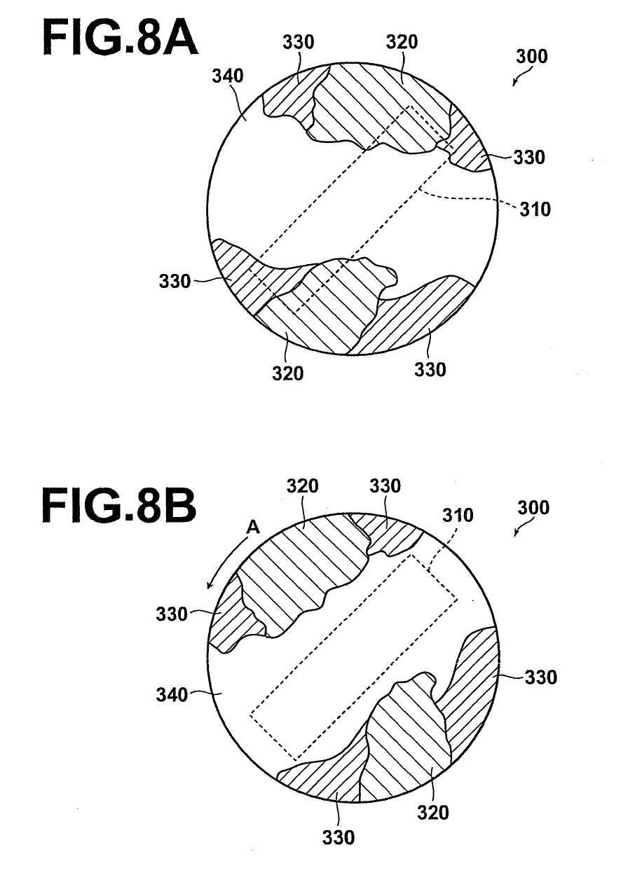

The first projection lens 51 and the second projection lens 52 will be described in detail. FIGS. 8A and 8B are plan views of a projection lens 300 which forms the first projection lens 51 or the second projection lens 52. A projection lens which has high optical performance (field curvature, astigmatic difference, distortion or the like of the lens is suppressed, and the telecentric characteristic of the lens is improved) is required to improve the exposure performance of the exposure apparatus. However, if the optical performance of the projection lens is improved through the entire region thereof, the production cost of the lens increases. Therefore, there is a problem that it is difficult to produce a large diameter lens. Meanwhile, in recent years, research revealed that in production of a projection lens, a predetermined region of the projection lens can be intentionally distorted so as to improve the optical performance of an arbitrary region of the projection lens.

Therefore, in production of the projection lens, for example, if a peripheral portion of the projection lens is distorted and distortion in a central portion of the projection lens is reduced, the optical performance of the projection lens in a region of the projection lens, including the central portion thereof, is improved. Further, a two-dimensional pattern formed by the DMD 80 is transmitted through the region of the projection lens, including the central portion thereof, and an image of the two-dimensional pattern is formed. For example, as illustrated in FIG. 8A, the field curvature is increased in the region 320 which is a peripheral region of the projection lens 300, and the distortion is increased in the region 330 of the projection lens. Meanwhile, the distortion in the central portion of the projection lens 300 is correspondingly reduced. Accordingly, a projection lens which has higher optical performance is produced.

However, when the two-dimensional pattern formed by the DMD 80 is projected onto a region 310 of the projection lens 300 and transmitted through the projection lens 300, a part of the two-dimensional pattern is transmitted through a region of the projection lens 300, in which the field curvature or distortion is high. Specifically, it is necessary that the two-dimensional pattern is projected onto a region 340 of the projection lens, which has good optical performance. Therefore, the projection lens 300 is rotated on the optical axis of the light of the two-dimensional pattern in a direction indicated with an arrow A in FIG. 8B so that the two-dimensional pattern is selectively projected onto the region 340 of the projection lens 300, which has good optical performance. When the projection lens 300 is rotated as described above, the region 340 which has good optical performance becomes the region 310 onto which the two-dimensional pattern is projected. Hence, it becomes possible to transmit the two-dimensional pattern through the region 340 which has good optical performance. Since the two-dimensional pattern is formed by transmitting the two-dimensional pattern at the region which has good optical performance, the image quality of the two-dimensional pattern projected onto the photosensitive material can be improved.

Further, it was difficult to produce a large diameter projection lens which has sufficient optical performance through the entire region of the projection lens. However, if an arbitrary region, such as a peripheral region of the large diameter projection lens, is distorted while the distortion in a region of the lens, including a central portion thereof, is reduced, the optical performance of the lens can be improved. If a large diameter projection lens as described above is used, it is possible to increase the exposure area and exposure speed.

Further, it is preferable that the two-dimensional pattern formed by the DMD 80 is a substantially rectangular pattern, such as the region 310 illustrated in FIGS. 8A and 8B. It is preferable that the length of the longer side of the rectangular pattern is twice or more of that of the shorter side thereof so as to form the two-dimensional pattern with light, reflected by the DMD 80, in a partial region of the projection lens, including the central portion thereof. This will be further described in section “1-2-2 DMD.”

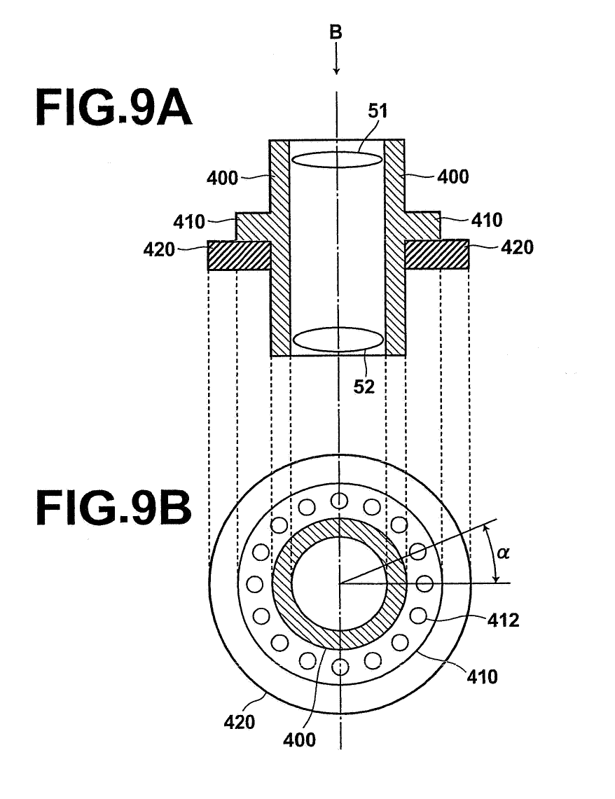

The imaging optical system 50 can rotate on the optical axis of the light of the two-dimensional pattern so that a two-dimensional pattern is selectively projected onto the region 340 of the projection lens 300, which has good optical performance. FIG. 9A is a schematic sectional side view of a lens barrel 400 including the imaging optical system 50. FIG. 9B is a schematic plan view of the lens barrel 400 which is viewed from a direction indicated with an arrow B in FIG. 9A. The lens barrel 400 has a brim-like flange 410 on the side thereof. In the flange 410, screw through-holes 412 are formed at every α[°]. Further, female screw holes (not illustrated) corresponding to the screw through-holes 412 are formed on a bracket 420 at every α[°], which is the same interval as that of the screw through-holes 412. A screw (not illustrated) is inserted into the screw through-hole 412 of the flange 410, and the screw is screwed into a corresponding female screw hole in the bracket 420. Accordingly, the flange 410 and the bracket 420 are fixed to each other. Since the lens barrel 400 is formed as described above, the lens barrel 400 can be rotated by α[°] on the optical axis of the first projection lens 51 and the second projection lens 52, and fixed at a position of an arbitrary angle. Further, when the flange 410 and the bracket 420 are fixed to each other with screws, screws may be inserted into all of the screw through-holes 412 and the screws may be screwed into the corresponding female screw holes in the bracket 420. Alternatively, screws may be inserted into, for example, two screw through-holes which are diagonally positioned, and the screws may be screwed into the corresponding female screw holes in the bracket 420.

When the lens barrel 400 is rotated, the first projection lens 51 and the second projection lens 52 also rotate. Then, exposure performance such as the focal point and image quality of the two-dimensional pattern which has been projected onto the photosensitive material 12 is measured. By measuring the exposure performance, the flange 410 and the bracket 420 are fixed to each other at a rotation position which has the highest exposure performance.

As described above, when the lens barrel 400 is rotated on the optical axis of the light of the two-dimensional pattern, the first projection lens 51 and the second projection lens 52 are rotated. Therefore, in each of the projection lenses forming the first projection lens 51 and the second projection lens 52, a region of the projection lens which has high optical performance becomes the region of the projection lens, onto which the two-dimensional pattern is projected.

Here, the lens barrel 400 may be formed so that each projection lens forming the first projection lens 51 or the second projection lens 52 can rotate independently. Further, the lens barrel 400 may be formed so that it can move vertically with respect to the optical axis of the two-dimensional pattern. Alternatively, the lens barrel 400 may be formed so that each projection lens forming the first projection lens 51 or the second projection lens 52 can move independently in a direction perpendicular to the optical axis of the two-dimensional pattern.

### 1-2-2 DMD

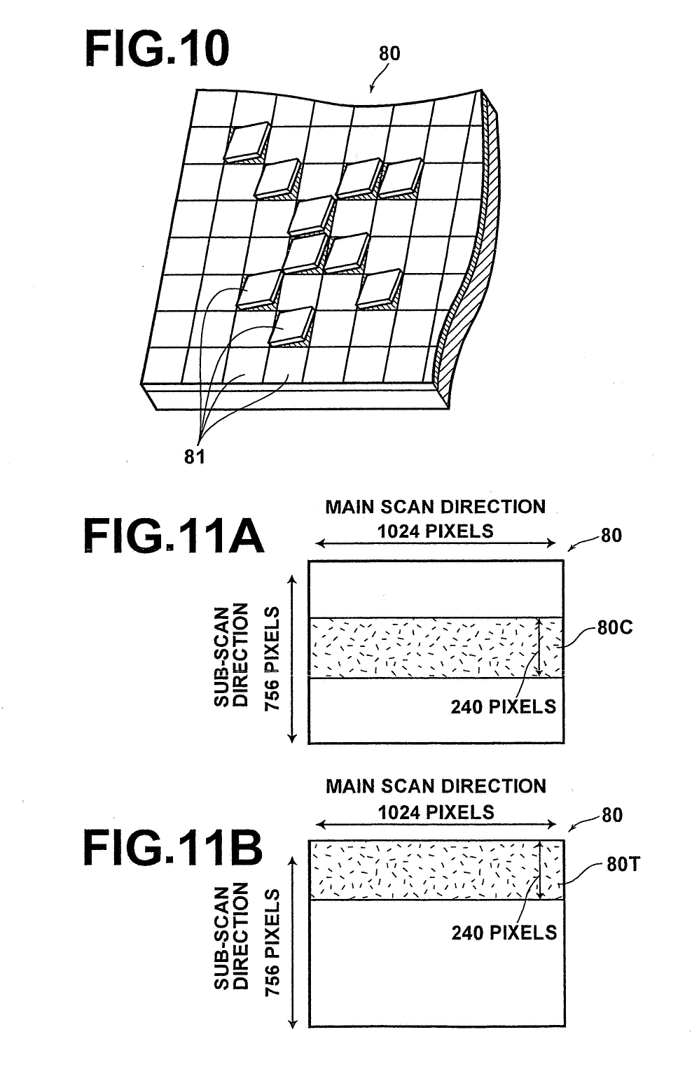

In the present embodiment, the DMD is used as the spatial light modulation means. However, the spatial light modulation means is not limited to the DMD as far as light representing a two-dimensional pattern is formed based on an image signal. FIG. 10 is a schematic perspective view of the DMD 80. The DMD 80 is a spatial light modulation means which forms a two-dimensional pattern by performing spatial light modulation, based on an image signal, on incident light which is emitted from a DMD illumination optical system 70. The DMD 80 includes a multiplicity of two-dimensionally arranged micromirrors 81 (for example, 1024 pixels×757 pixels). Further, the DMD 80 is connected to a controller (not illustrated) which includes a data processing unit and a mirror drive control unit. The data processing unit generates, based on an image signal, a control signal for controlling drive of each of the micromirrors 81 which are arranged in the DMD 80. The mirror drive control unit controls the angle of a reflection surface of each of the micromirrors 81 based on the control signal generated by the data processing unit. The angle of the reflection surface of each of the micromirrors 81 is inclined at a predetermined angle by the data processing unit and the mirror drive control unit. Accordingly, although the DMD 81 is illuminated with light, a two-dimensional pattern is formed only with light reflected by a micromirror 81 which is inclined at a predetermined angle. Then, light forming the two-dimensional pattern is incident on the imaging optical system 50.

As described above, in the present embodiment, when the lens is produced, the peripheral portion of the projection lens forming the first projection lens 51 or the second projection lens 52 is distorted, and the distortion at the central portion of the lens is reduced. Accordingly, the optical performance of the projection lens including the central portion thereof is improved, and an image is formed by transmitting the two-dimensional pattern through the region including the central portion (please refer to “1-2-1 Imaging Optical System”). It is preferable that the two-dimensional pattern formed by the DMD 80 is like a region 310, illustrated in FIG. 8B, in order to form the two-dimensional pattern in a partial region of the projection lens, including the central portion thereof. The region 310 is a substantially rectangular region, and the length of the longer side of the region 310 is twice or more of that of the shorter side of the region 310. The DMD 80 of the present embodiment forms the substantially rectangular two-dimensional pattern of which the length of the longer side is twice or more of that of the shorter side thereof by controlling drive of a part of the micromirrors 81 of the DMD 80.

The DMD 80 will be described in detail with reference to FIGS. 11A and 11B. In the DMD 80, micromirrors 81 are two-dimensionally arranged. For example, 1024 micromirrors 81 representing 1024 pixels are arranged in a main scanning direction, namely row direction. The main scanning direction is a main scanning direction when scanning is performed during exposure. Further, 756 micromirrors 81 representing 756 pixels are arranged in the sub-scanning direction, namely column direction. The sub-scanning direction is a sub-scanning direction when scanning is performed during exposure. In the present embodiment, a part (for example, 240 pixels) of the 756 pixels of the micromirrors 81 arranged in the column direction are used, and a two-dimensional pattern of 1024 pixels×240 pixels is formed. Here, it is preferable that the number of micromirrors 81 used with respect to the column direction is approximately ½ through ⅕ of that of the micromirrors 81 arranged in the row direction.

Only a part of the micromirrors 81 in the central portion of the DMD 80, such as a region 80C in FIG. 11A, may be used. Alternatively, micromirrors in the vicinity of an end of the DMD 80, such as a region 80T in FIG. 11B, may be used. Further, if failure occurs in a micromirror which is used, a region of the DMD 80, in which failure has not occurred in micromirrors, may be used, or the like. The region of the DMD 80, including micromirrors which are used, may be appropriately changed according to the condition of the micromirrors or the like.

As described above, in the micromirrors 81 which form the DMD 80, a part of the micromirrors 81 are used with respect to the column direction. Therefore, a substantially rectangular two-dimensional pattern can be formed. In the substantially rectangular two-dimensional pattern, the length of the longer side is longer than that of the shorter side thereof. Further, it becomes possible to easily project the two-dimensional pattern only on a high optical performance region of the projection lens forming the first projection lens 51 or the second projection lens 52. Further, data processing time of the DMD 80 is proportional to the number (number of pixels) of the micromirrors 81 controlled. Therefore, if only a part of the micromirrors 81 are used with respect to the column direction, it is possible to increase data processing speed. Accordingly, it is possible to increase exposure speed. Further, if the size of the two-dimensional pattern formed by the DMD 80 is reduced, it is possible to reduce the size of a microlens array 55, which is expensive. Hence, it is possible to reduce the cost for production of the exposure apparatus.

In the above description, only a part of the micromirrors 81 were used with respect to the column direction of the DMD 80 to form the substantially rectangular two-dimensional pattern. However, a DMD, in which the number of micromirrors arranged in the direction of the longer side thereof is twice or more of that of micromirrors arranged in the direction of the shorter side thereof, may be used.

### 1-3 Pair of Wedge Prisms

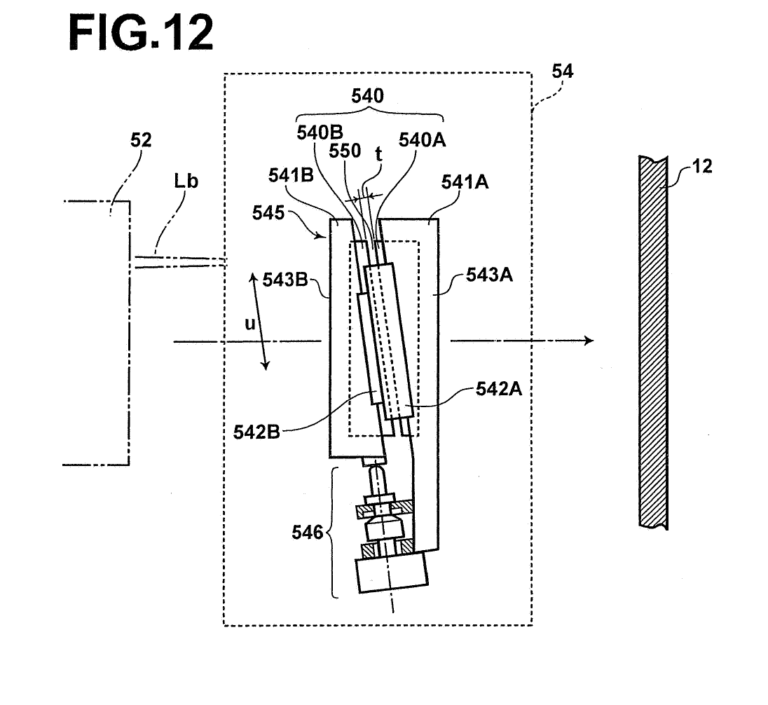

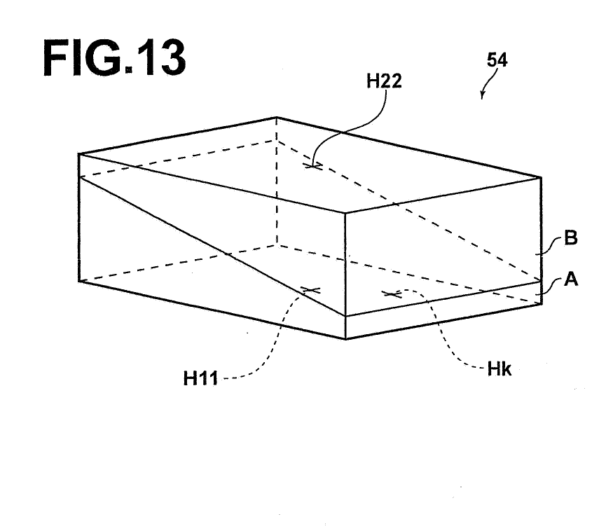

FIG. 12 is a side view illustrating the structure of a pair 54 of wedge prisms. FIG. 13 is a schematic perspective view of the pair 54 of wedge prisms. The pair 54 of wedge prisms is a focus adjustment means for adjusting focus by changing the optical path length of light of a two-dimensional pattern when the two-dimensional pattern is formed. The pair 54 of wedge prisms includes a slide unit 545 and a drive unit 546 for moving the slide unit 545. The slide unit 545 includes wedge prisms 540A and 540B. The slide unit 545 also includes base prism holders 541A and 541B for fixing the wedge prisms 540A and 540B, respectively. The slide unit 545 also includes a slide base 542A and a slider 542B which moves on the slide base 542A. The slide base 542A is arranged at either end of the base prism holder 541A. A pair of prisms A and B, as illustrated in FIG. 13, may be used as the wedge prisms 540A and 540B in the pair 54 of wedge prisms. The pair of prisms A and B is produced, for example, by diagonally cutting a parallel flat plate made of a transparent material such as glass and acrylic with respect to parallel flat surfaces H11 and H12 of the parallel flat plate.

In FIG. 12, an air layer 550 which has width t (for example 10 [um]) is provided between the wedge prisms 540A and 540B, and the wedge prisms 540A and 540B are fixed to base prism holders 541A and 541B, respectively. Further, the combination of the slide base 542A and the slider 542B enables the wedge prisms 540A and 540B to linearly slide. The drive unit 546 moves the slide unit 545 in a single direction (direction indicated with arrow u in FIG. 12) so that the wedge prism 540A and the wedge prism 540B are relatively moved without changing the width t of the air layer 550. When the slide unit 545 is moved, the thickness (thickness obtained by deducting the width t of the air layer 550 from the thickness of the parallel flat plate) of the pair 54 of wedge prisms in the direction of the optical axis of the two-dimensional pattern is changed. Specifically, the optical path length of light which forms the two-dimensional pattern is changed by the pair 54 of wedge prisms.

Since the pair of wedge prisms is arranged between the second projection lens 52 and the photosensitive material 12, as described above, the optical length of light of the two-dimensional pattern can be easily adjusted. Therefore, when a two-dimensional pattern formed by the second projection lens 52 is formed on the photosensitive material 12, focus can be easily adjusted compared with the related art. Further, the two-dimensional pattern can be formed in short time.

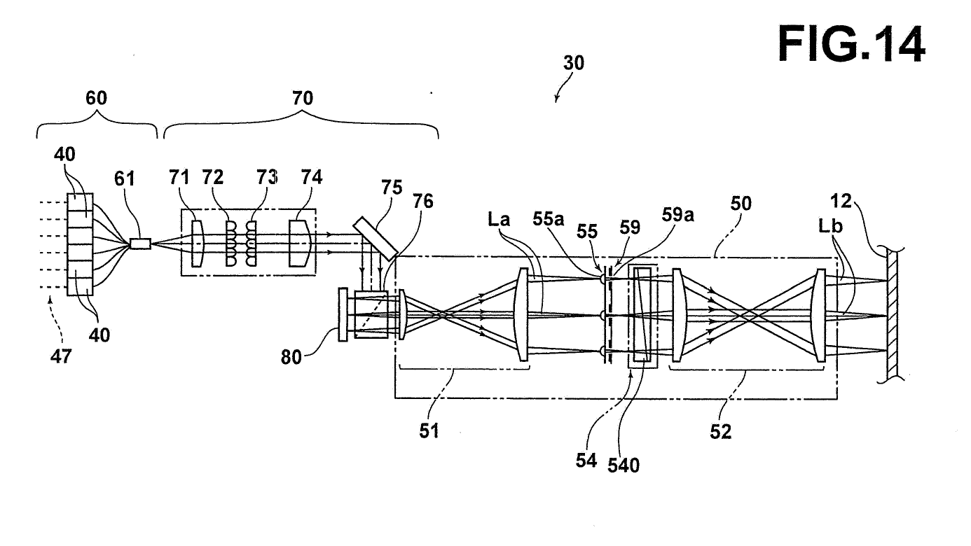

As illustrated in FIG. 14, the pair 54 of wedge prisms may be arranged between the microlens array 55 and the second projection lens 52. Accordingly, focus of the two-dimensional pattern may be adjusted by changing the optical path length of light of the two-dimensional pattern.

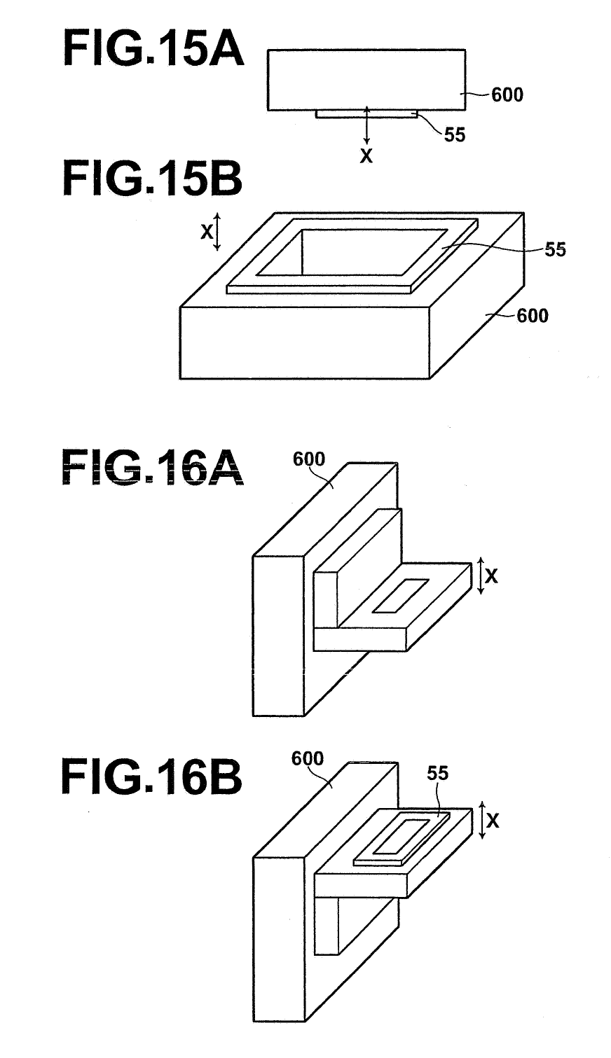

In the above description, the pair 54 of wedge prisms was used as the focus adjustment means. However, the focus adjustment means is not limited to the pair 54 of wedge prisms. Any focus adjustment means which realizes high accuracy of beam positions may be used as far as focus is adjusted without changing the position of the projection lens which forms the imaging optical system 50. For example, as illustrated in FIGS. 15A, 15B, 16A and 16B, focus may be adjusted by moving the microlens array 55 in the focal direction (direction indicated with an arrow X in FIGS. 15A, 15B, 16A and 16B) using a piezo element 600. Since the piezo element 600 is used, it is possible to slightly move the microlens array 55 in the focal direction while suppressing displacement of the microlens array 55 in a direction perpendicular to the focal direction. Hence, it is possible to adjust focus while the accuracy of beam positions is stably maintained.

### 2. Exposure Method

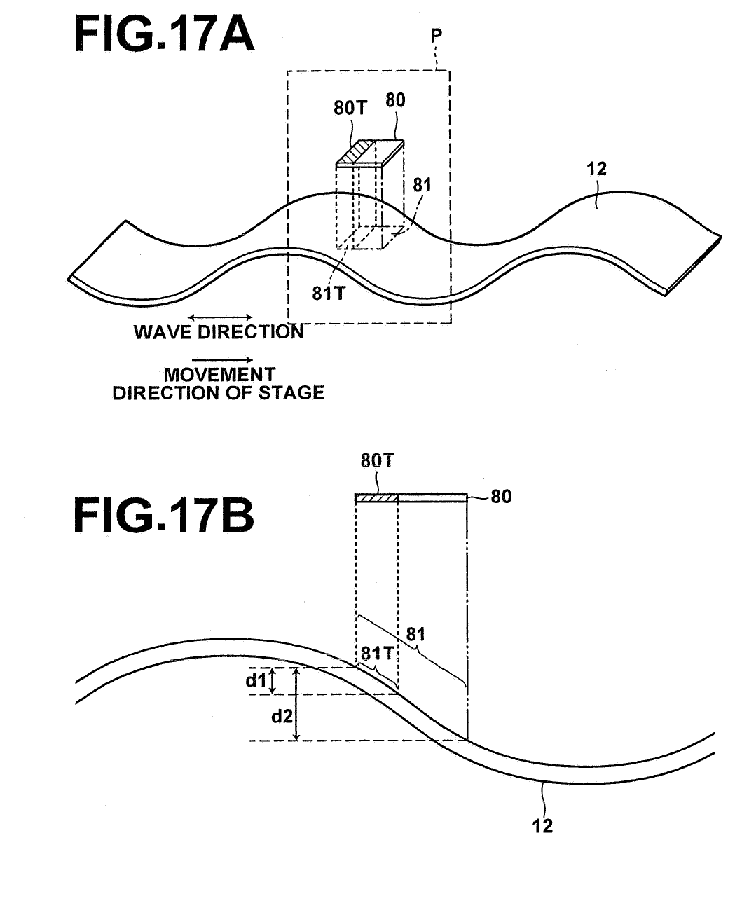

Next, an exposure method of the exposure apparatus 10 will be described. FIG. 17A is a schematic perspective view illustrating a positional relationship between the photosensitive material 12 and the DMD 80. In the above description, the exposure apparatus 10 includes 10 exposure heads 30, each of which has the DMD 80, as illustrated in FIG. 2. However, in FIG. 17A or 17B, only one DMD 80 is illustrated to simplify the diagram. In the following description, only one DMD 80 is used to simplify explanation.

As illustrated in FIG. 17A, when micromirrors 81 in the region 80T of the DMD 80 are used, the photosensitive material 12 is exposed to light in a manner in which the direction of the shorter side of the region 80T is the wave direction of the photosensitive material 12 (the direction of the shorter side of the region 80T is the movement direction of the photosensitive material 12). Here, the wave direction of the photosensitive material 12 will be specifically described. In the present embodiment, the photosensitive material 12 is a photosensitive material which is produced by applying a photosensitive substance on a glass substrate. The glass substrate is not flat but wavy (therefore, the photosensitive material 12 is also wavy). Further, the waves are directional. In other words, the height of waves is high in a certain direction and the height of waves is low in other directions. In the present embodiment, the direction in which the height of the waves is high is referred to as the wave direction of the photosensitive material 12 (glass substrate). In FIG. 17A, the exposure area 81 is an exposure area when the two-dimensional pattern is formed using all of the micromirrors 81 of the DMD 80. The exposure area 81T is an exposure area when the two-dimensional pattern is formed using the micromirrors 81 in the region 80T of the DMD 81.

FIG. 17B is a side view of the photosensitive material 12 and the DMD 80. A portion of FIG. 17A, which is enclosed with frame P of a broken line, is enlarged in FIG. 17B. As illustrated in FIG. 17B, when a two-dimensional pattern is formed using all of the micromirrors 81 of the DMD 80, the maximum difference in depth (maximum difference in the height of the surface of the photosensitive material 12 in the exposure area 81) with respect to the photosensitive material 12 in the exposure area 81 is d2. Meanwhile, when the micromirrors 81 in the region 80T of the DMD 80 are used, the maximum difference in depth with respect to the photosensitive material 12 in the exposure area 81T is d1. As illustrated in FIG. 17B, the maximum difference in depth is d1<d2. When the difference in depth is small, the degree of wave of the photosensitive material 12 in the two-dimensional pattern is small. Therefore, if the difference in depth is small, it is possible to adjust the focal position of the two-dimensional pattern to a more appropriate position.

Further, when exposure for one frame ends, the stage 14 moves in the scanning direction. Accordingly, the photosensitive material 12 moves. Then, the position of the exposure area 81T changes, and the degree of wave of the photosensitive material 12 in the exposure region 81T changes. Therefore, the focal position also changes. However, since focus is adjusted by the pair 54 of wedge prism, the focal position is immediately adjusted. Therefore, when exposure is performed, long focal depth corresponding to the wave of the photosensitive material 12 is achieved.

As described above, when the substantially rectangular two-dimensional pattern is formed by using a part of the micromirrors 81 of the DMD 80 with respect to the column direction, exposure is performed in a manner in which the direction of the shorter side of the two-dimensional pattern is the wave direction of the photosensitive material 12. Accordingly, it is possible to reduce the degree of wave of the photosensitive material 12 in the exposure area 81T. Therefore, it is possible to appropriately adjust the focal position of the two-dimensional pattern. Further, exposure can be performed as if the focal depth of the exposure apparatus 10 is larger than that of an exposure apparatus according to the related art. Therefore, it is possible to improve the image quality of exposure.

As illustrated in FIG. 2, in actual exposure apparatuses, an exposure head 30 is attached to the scanner 24 in a manner in which the column direction of the micromirrors of the DMD 80 and the scan direction form a predetermined setting inclination angle therebetween. Therefore, an exposure area 32 (corresponding to the exposure area 81T in FIGS. 17A and 17B) formed by each of the exposure heads 30 is a rectangular area inclined with respect to the scan direction. Ideally, the direction of the shorter side of the exposure area 81T should be exactly the same as the wave direction of the photosensitive material 12 so as to minimize the degree of the wave of the photosensitive material 12 in the exposure area 81T. However, the exposure area 81T may be inclined at the predetermined setting inclination angle. In that case, the wave direction of the photosensitive material 12 should be closer to the direction of the shorter side of the exposure area 81T than that of the longer side of the exposure area 81T.

1-10. (canceled)

11. An exposure apparatus comprising:
a light source for emitting exposure light;
a spatial light modulation means for performing spatial light modulation, based on an image signal, on the exposure light emitted from the light source;
an imaging means for forming an image on a photosensitive material with the exposure light on which spatial light modulation has been performed; and
a focus adjustment means for adjusting focus by changing the optical path length of the exposure light on which spatial light modulation has been performed when the image is formed on the photosensitive material with the exposure light on which spatial light modulation has been performed, wherein the imaging means forms the image only by a substantially rectangular region thereof, including a central portion thereof, with the exposure light on which spatial light modulation has been performed.

12. An exposure apparatus as defined in claim 11, wherein the imaging means forms the image by a substantially rectangular region thereof, of which the length of the longer side is twice or more of that of the shorter side thereof, with the exposure light on which spatial light modulation has been performed.

13. An exposure apparatus as defined in claim 11, wherein the focus adjustment means includes a pair of wedge prisms, of which the thickness in the direction of the optical axis of the exposure light on which spatial light modulation has been performed changes, wherein focus is adjusted by moving at least one of the pair of wedge prisms when the image is formed on the photosensitive material with the exposure light on which spatial light modulation has been performed.

14. An exposure apparatus as defined in claim 11, wherein the focus adjustment means includes an optical system having a plurality of optical components and a piezo element, and wherein focus is adjusted by adjusting a distance between the optical components by the piezo element when the image is formed on the photosensitive material with the exposure light on which spatial light modulation has been performed.

15. An exposure apparatus as defined in claim 11, wherein the imaging means includes a lens, and wherein the imaging means can rotate on the optical axis of the lens or move vertically with respect to the optical axis thereof.

16. An exposure apparatus as defined in claim 11, wherein the light source is a laser light source which emits laser beam emitted by a semiconductor laser element.

17. An exposure apparatus as defined in claim 12, wherein the focus adjustment means includes a pair of wedge prisms, of which the thickness in the direction of the optical axis of the exposure light on which spatial light modulation has been performed changes, wherein focus is adjusted by moving at least one of the pair of wedge prisms when the image is formed on the photosensitive material with the exposure light on which spatial light modulation has been performed.

18. An exposure apparatus as defined in claim 12, wherein the focus adjustment means includes an optical system having a plurality of optical components and a piezo element, and wherein focus is adjusted by adjusting a distance between the optical components by the piezo element when the image is formed on the photosensitive material with the exposure light on which spatial light modulation has been performed.

19. An exposure apparatus as defined in claim 12, wherein the imaging means includes a lens, and wherein the imaging means can rotate on the optical axis of the lens or move vertically with respect to the optical axis thereof.

20. An exposure apparatus as defined in claim 12, wherein the light source is a laser light source which emits laser beam emitted by a semiconductor laser element.

21. An exposure apparatus as defined in claim 13, wherein the imaging means includes a lens, and wherein the imaging means can rotate on the optical axis of the lens or move vertically with respect to the optical axis thereof.

22. An exposure apparatus as defined in claim 13, wherein the light source is a laser light source which emits laser beam emitted by a semiconductor laser element.

23. An exposure apparatus as defined in claim 16, wherein the laser light source is a bundle-type fiber light source formed by bundling a plurality of optical fibers, and wherein laser beam emitted by the semiconductor laser element is incident on an end of each of the optical fibers and emitted from the opposite end thereof.

24. An exposure apparatus as defined in claim 20, wherein the laser light source is a bundle-type fiber light source formed by bundling a plurality of optical fibers, and wherein laser beam emitted by the semiconductor laser element is incident on an end of each of the optical fibers and emitted from the opposite end thereof.

25. An exposure apparatus as defined in claim 22, wherein the laser light source is a bundle-type fiber light source formed by bundling a plurality of optical fibers, and wherein laser beam emitted by the semiconductor laser element is incident on an end of each of the optical fibers and emitted from the opposite end thereof.

26. An exposure apparatus as defined in claim 23, wherein the fiber light source combines laser beams emitted by a plurality of semiconductor laser elements by causing the laser beams to be incident on a single optical fiber.

27. An exposure apparatus as defined in claim 24, wherein the fiber light source combines laser beams emitted by a plurality of semiconductor laser elements by causing the laser beams to be incident on a single optical fiber.

28. An exposure apparatus as defined in claim 25, wherein the fiber light source combines laser beams emitted by a plurality of semiconductor laser elements by causing the laser beams to be incident on a single optical fiber.

29. An exposure method comprising the steps of:
emitting exposure light;
performing spatial light modulation, based on an image signal, on the emitted exposure light;
forming an image on a photosensitive material by an imaging means with the exposure light on which spatial light modulation has been performed; and
adjusting focus by changing the optical path length of the exposure light on which spatial light modulation has been performed when the image is formed on the photosensitive material with the exposure light on which spatial light modulation has been performed, wherein in the step of forming the image, the image is formed only by a substantially rectangular region of the imaging means, including a central portion thereof, with the exposure light on which spatial light modulation has been performed, and wherein exposure is performed in such a manner that the direction of the shorter side of the substantially rectangular region is directed to a wave direction of the photosensitive material.

30. An exposure method as defined in claim 29, wherein in the step of emitting exposure light, laser beam emitted by a semiconductor laser element is emitted as the exposure light.
